(19) United States
(12) Patent Application Publication
(10) Pub. No.: US 2003/0114110 A1
(43) Pub. Date: Jun. 19, 2003

(54) Automatic frequency control algorithm

(76) Inventors: Erik Dahlback, Veberod (SE); Jonas Ohlsson, Malmo (SE)

Correspondence Address: Spencer C. Patterson, Jenkens & Gilchrist, A Professional Corporation, 1445 Ross Avenue, Suite 3200, Dallas, TX, 75202, US

(21) Appl. No.: 10/025,063

(22) Filed: Dec. 19, 2001

(51) Int. Cl. H04B 17/00

(52) U.S. Cl. 455/67.1; 455/136; 455/63

(57) ABSTRACT

In a mobile communication device, an automatic frequency control method and apparatus are described that are capable of minimizing the number of timing changes that have to be made due to frequency errors without increasing the overall frequency sensitivity of the receiver unit. A frequency control unit of the present invention is capable of detecting a magnitude and direction of a timing drift that may arise from a frequency error. The automatic frequency control unit thereafter adjusts the frequency of the receiver unit in such a way so as to reverse the direction of the timing drift before it becomes too large. In this way, the number of timing changes that have to be made is reduced.

### BACKGROUND OF THE INVENTION

1. Field of the Invention

The present invention is related to automatic frequency control in mobile communication systems and, more particularly, to an automatic frequency control method and apparatus for improving long-term timing synchronization.

2. Description of the Related Art

In code division multiple access (CDMA) mobile communication systems, such as the Universal Mobile Telecommunication System (UMTS), data is transmitted using a spread spectrum modulation technique wherein the data is scattered across the entire range of available frequencies. Each user is assigned a unique spreading code which is used to spread the data in such a way that only the same code may be used to recover the data. The spreading code is called a pseudo-random noise (PN) code and is composed of a sequence of 1's and 0's (or 1's and −1's), called “chips,” that are distributed in a pseudo-random of 1's and 0's (or 1's and −1's), called “chips,” that are distributed in a pseudo-random manner and has noise-like properties. The number of chips used to modulate (spread) one data bit, or “chips/bit,” may vary and depends, in part, on the data rate of the traffic channel and the chip rate of the system. To recover the transmitted data, the received signal must be demodulated with the same PN code using the same chip rate. Furthermore, the timing of the demodulation must be synchronized, that is, the PN code must be applied to the received signal at the correct instant.

Achieving the correct timing can be difficult due to multipath fading effects wherein the same transmitted signal travels along multiple paths to arrive at a receiver unit at different times. Most CDMA systems use RAKE receivers that are capable of tracking and gathering the various multipath signals. The PN code is then applied to each multipath signal separately. A timing algorithm in the receiver unit tracks the different multipath signals in time to ensure that the correct or at least optimal timing is used for each multipath signal. This is done by adjusting (e.g., adding to or subtracting from) the timing of the received multipath signal by a fraction of a chip. In UMTS, for example, the maximum timing adjustment for a multipath signal is specified as one quarter-chip.

Alas, the timing adjustments have undesirable effects in the receiver unit in terms of the amount of current consumed and the processing power required for interrupt-handling controls. In addition, for full duplex systems where both signal transmission and reception can occur at the same time, a timing adjustment for the reception of a certain multipath signal means that the same timing adjustment needs to be made on the transmission to the base station. Unfortunately, timing adjustments on the transmission from the receiver unit to the base station generally result in signal degradation at the base station. Thus, the fewer number of timing adjustments that have to be made per timing unit, the better.

The number of timing adjustments that have to be made per timing unit is dependent on two factors: (1) the speed with which the receiver unit is moving relative to the base station (or the speed with which the obstacles that are causing the multipath signals are moving relative to the base station); and (2) the frequency difference or error between the receiver unit and the base station.

With regard to the second factor, decreasing the size of the error between the receiver unit reference frequency and the base station frequency can reduce the number of timing adjustments that have to be made. In fact, mobile communication systems such as UMTS specify that the reference frequency of the receiver unit must be within 0.1 ppm of the base station frequency. The accuracy of the receiver unit reference frequency is controlled by an automatic frequency control (AFC) unit that monitors and maintains the frequency of the receiver unit within the required tolerance. An exemplary receiver unit having an automatic frequency control unit is depicted with functional block diagrams in FIG. 1. As can be seen, the receiver unit 100 includes a transceiver unit 102, an automatic frequency control unit 104, a frequency conversion unit 106, a digital-to-analog converter (DAC) 108, and a voltage-controlled oscillator (VCO) 110. Each of these components are described briefly below.

The transceiver unit 102 is a typical CDMA transceiver unit that is capable of receiving a signal and down converting the signal to baseband. The transceiver unit 102 is also capable of up converting a baseband signal to a radio frequency for transmission. Such CDMA transceiver units usually employ an array of receivers in order to improve the reception of the incoming multipath signals. The multipath signals are then gathered by the transceiver unit 102 and provided to the automatic frequency control unit 104 for frequency error estimation. Frequency error estimates from one or more separate multipath signals may then be statistically combined (e.g., averaged, summed) to form a single error estimate.

An algorithm in the automatic frequency control unit 104 estimates the frequency error using the frequency of the signal provided by the transceiver unit 102 and the reference frequency of the receiver unit 100. The algorithm calculates the frequency error Δƒ according to the following equation:

Δƒ=ƒ_{basestation}−ƒ_{ref} (1)

where ƒ_{basestation} is the frequency of signal received from the base station, and ƒ_{ref} is the reference frequency of the receiver unit. The frequency error Δƒ is then provided to the frequency conversion unit 106 to be used as part of the process of controlling the reference frequency of the receiver unit 100

The frequency conversion unit 106 receives the frequency error Δƒ from the automatic frequency control unit 104 and converts this error to into a digital value. The digital value corresponds to the size of the frequency error Δƒ calculated by the automatic frequency control unit 104. As the size of the frequency error Δƒ increases or decreases, the digital value increases or decreases accordingly. The digital value is subsequently provided as an input to the DAC 108.

The DAC 108 receives the digital value corresponding to the frequency error Δƒ from the conversion unit 106 and converts this digital value into an analog value. The analog value may be in the form of an analog voltage signal or an analog current signal, although the analog voltage signal is used in this description. An important parameter of the DAC 108 is its resolution, DACres (in Volts/bit). This parameter determines how small or large a change in the analog voltage signal will be produced by an incremental change or step in the digital value. The resolution DACres depends on the range of analog values that can be outputted by the DAC 108 and the number of bits at the input of the DAC 108. For example, the DAC 108 may be a 10-bit DAC with a voltage range of 3.6 Volts. The resolution DACres may then be calculated as a ratio of the voltage range over the number of input bits. An incremental change or step in the digital value of the frequency error Δƒ results in a change or step in the analog voltage signal equal to DACres volts. The analog voltage signal is thereafter provided as a control signal to the VCO 110.

The VCO 110 receives the analog voltage signal from the DAC 108 and generates a frequency that is directly proportional to the magnitude of the received voltage signal. As the input voltage signal to the VCO 108 increases, the generated frequency also increases, and vice versa. The generated frequency is then provided as a reference frequency to the transceiver unit 102 for use in receiving and transmitting signals to and from the receiver unit 100. Through this process, the automatic frequency control unit 104 is able to control and maintain the frequency of the receiver unit 100 at or near the frequency of the base station.

From the foregoing, it can be seen that an important parameter of the VCO 110 is its sensitivity, VCOsen (in Hz/Volt). This parameter determines how large or small a change in the reference frequency will result from an incremental change or step in the analog input voltage signal. Moreover, the sensitivity VCOsen of the VCO and the resolution DACres of the DAC determine the overall frequency sensitivity, FREQsen (in Hz/bit), of the receiver unit 100. The frequency sensitivity FREQsen may be determined as follows:

FREQsen=DACres·VCOsen (2)

In general, a low value of FREQsen is preferred in order to provide more precise control of the reference frequency of the receiver unit 100 and thereby reduce the size of the frequency errors that may arise. Reducing the size of the frequency errors, in turn, has the effect of reducing the number of timing adjustments that have to be made. However, it is expensive in terms of both current consumption and available circuit area to implement a very low frequency sensitivity. On the other hand, the frequency sensitivity value FREQsen should not be so high that the tolerance requirements of the receiver unit cannot be met. As mentioned earlier, in UMTS systems, the receiver unit is required to maintain a frequency that is within 0.1 ppm of the base station frequency.

Accordingly, it is desirable to be able to provide an improved automatic frequency control unit that is capable of minimizing the number of timing changes that have to be made due to frequency errors without increasing the overall frequency sensitivity of the receiver unit, thereby avoiding the costs and complexity involved therewith.

### SUMMARY OF THE INVENTION

The present invention is related to an automatic frequency control method and apparatus that is capable of minimizing the number of timing changes that have to be made due to frequency errors without increasing the overall frequency sensitivity of the receiver unit. A frequency control unit of the present invention is capable of detecting a magnitude and direction of a timing drift that may arise from a frequency error. The reference frequency of the receiver unit is then adjusted in such a way so as to reverse the direction of the timing drift before it becomes too large. In this way, the number of timing changes that have to be made is reduced.

In general, in one aspect, the invention is related to a method of controlling frequency in a mobile communication device. The method comprises estimating a frequency error for the mobile communication device, calculating a total timing drift for the mobile communication device using the estimated frequency error, and determining whether a magnitude of the frequency error is greater than a predefined error threshold. The method further comprises determining whether a magnitude of the total timing drift is greater than a predefined drift threshold if the magnitude of the frequency error is determined to be not greater than the predefined error threshold, and adjusting the frequency of the mobile communication device to reverse a direction of the total timing drift if the magnitude of the total timing drift is determined to be greater than the predefined drift threshold.

In general, in another aspect, the invention is related to a mobile communication device. The mobile communication device comprises a transceiver unit, a voltage controlled oscillator adapted to generate a reference frequency signal for the transceiver unit, and a frequency control unit adapted to control the reference frequency generated by the voltage controlled oscillator. The frequency control unit is configured to estimate a frequency error for the mobile communication device, calculate a total timing drift for the mobile communication device using the estimated frequency error, and determine whether a magnitude of the frequency error is greater than a predefined error threshold. The frequency control unit is further configured to determine whether a magnitude of the total timing drift is greater than a predefined drift threshold if the magnitude of the frequency error is determined to be not greater than the predefined error threshold, and to adjust the frequency of the mobile communication device to reverse a direction of the total timing drift if the magnitude of the total timing drift is determined to be greater than the predefined drift threshold.

In general, in yet another aspect, the invention is related to a method of controlling frequency in a mobile communication device. The method comprises estimating a long-term frequency error and a short-term frequency error for the mobile communication device, calculating a total timing drift for the mobile communication device using the long-term frequency error, and determining whether a magnitude of the short-term frequency error is greater than a predefined error threshold. The method further comprises determining whether a magnitude of the total timing drift is greater than a predefined drift threshold if the magnitude of the short-term frequency error is determined to be not greater than the predefined error threshold, and adjusting the frequency of the mobile communication device to reverse a drift direction of the total timing drift if the magnitude of the total timing drift is determined to be greater than the predefined drift threshold.

In general, in still another aspect, the invention is related to a mobile communication device. The mobile communication device comprises a transceiver unit, a voltage controlled oscillator adapted to generate a reference frequency signal for the transceiver unit, and a frequency control unit adapted to control the reference frequency generated by the voltage controlled oscillator. The frequency control unit is configured to estimate a long-term frequency error and a short-term frequency error for the mobile communication device, calculate a total timing drift for the mobile communication device using the long-term frequency error, and determine whether a magnitude of the short-term frequency error is greater than a predefined error threshold. The frequency control unit is further configured to determine whether a magnitude of the total timing drift is greater than a predefined drift threshold if the magnitude of the short-term frequency error is determined to be not greater than the predefined error threshold, and to adjust the frequency of the mobile communication device to reverse a drift direction of the total timing drift if the magnitude of the total timing drift is determined to be greater than the predefined drift threshold.

It should be emphasized that the term comprises/comprising, when used in this specification, is taken to specify the presence of stated features, integers, steps, or components, but does not preclude the presence or addition of one or more other features, integers, steps, components, or groups thereof.

### BRIEF DESCRIPTION OF THE DRAWINGS

A more complete understanding of the method and system of the present invention may be had by reference to the following detailed description when taken in conjunction with the accompanying drawings, wherein:

FIG. 1 illustrates a prior art receiver having a conventional automatic frequency control unit;

FIG. 2 illustrates a receiver having an improved automatic frequency control unit according to some embodiments of the invention;

FIG. 3 illustrates an automatic frequency control algorithm according to some embodiments of invention; and

FIG. 4 illustrates another automatic frequency control algorithm according to some embodiments of the invention.

### DETAILED DESCRIPTION OF THE DRAWINGS

Following is a detailed description of the drawings wherein like and similar reference numerals are used to designate like and similar elements throughout the various figures.

Embodiments of the invention provide a method and apparatus for reducing the number of timing changes that must be made due to frequency errors in a mobile communication device. In some embodiments, the method and apparatus of the present invention is capable of calculating a total timing drift for the mobile communication device using an estimated frequency error. If a magnitude of the total timing drift is greater than a certain predefined drift threshold, the reference frequency of the mobile communication device is adjusted to reverse a direction of the drift. Under such an arrangement, the timing drift is prevented from becoming too large in any direction, thereby reducing the number of timing changes that have to be made as a result of frequency differences between the receiver unit and the base station.

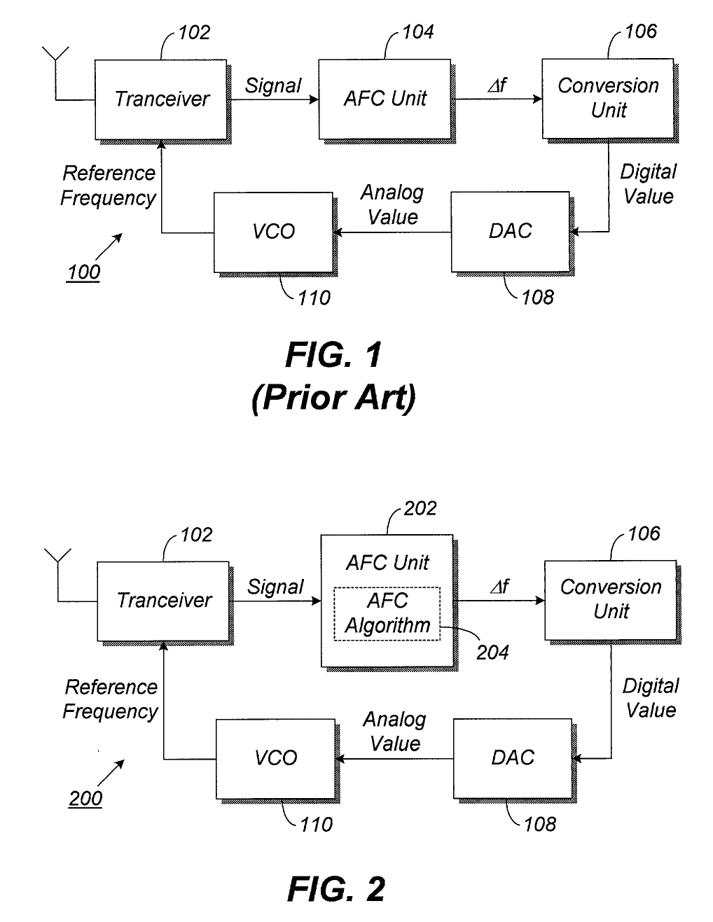

Referring now to FIG. 2, a receiver unit 200 according to some embodiments of the invention is shown. The receiver unit 200 is similar to the receiver unit 100 of FIG. 1 in that it shares a number of the same functional components, namely, the transceiver unit 102, the conversion unit 106, the DAC 108, and the VCO 110. The automatic frequency control unit 202 of the receiver unit 200, however, is an improved automatic frequency control unit in accordance with the principles and teachings of the present invention. In some embodiments, the automatic frequency control unit 202 uses or operates in accordance with an automatic frequency control algorithm 204 that is capable of controlling the VCO 110 in such a way so as to reduce the number of timing changes that must be made due to frequency errors. More specifically, the automatic frequency control algorithm 204 decreases the number of additions or subtractions of chip fractions (on a per time unit basis) that have to be performed on transmissions from the receiver unit 200 to the base station due to frequency errors. Operation of the automatic frequency control algorithm 204 will now be described.

As an initial manner, in CDMA systems such as UMTS, the frequency accuracy requirement is specified as 0.1 ppm. For a representative UMTS frequency of 2 GHz, a 0.1 ppm accuracy translates to approximately 200 Hz (0.1E−6×2E9=200). Thus, the frequency error Δƒ of the receiver unit is required to be no more than approximately 200 Hz of the base station frequency. Furthermore, the chip rate is specified in UMTS as 3.84 Mcps. For this chip rate, a 0.1 ppm accuracy means that the timing of the chips is allowed to slide or drift by no more than approximately 0.4 chips/second (0.1E−6×3.84=0.384). Using the above 200 Hz frequency error limitation and the 0.4 chips/second timing drift limitation, the equation for the chip rate timing drift t can be expressed in chips/second as follows:

$$\frac{Δ f}{t} = \frac{200}{0.4} ⇒ t = \frac{Δ f}{500} \qquad ( 3 )$$

Also, in CDMA systems such as UMTS, the frequency error Δƒ is determined on a per time slot basis or a fraction of a time slot basis. The duration of one time slot is 1/1500 seconds, and there are 15 time slots in each UMTS radio frame. Thus, the total timing drift T for a given time unit having x number of time slots may be expressed in chips according to Equation (4):

$$T = t \cdot \frac{1}{1500} \cdot x = \frac{Δ f}{500} \cdot \frac{1}{1500} \cdot x = \frac{x \cdot Δ f}{750000} \qquad ( 4 )$$

where x is the number of time slots in the given time unit. If Δƒ is varying with each time slot, which is often the case, then the total timing drift T for a given time unit having x number of time slots may be expressed in chips according to Equation (5):

$$T = \frac{1}{750000} \cdot {\sum }_{k = 1}^{x} Δ {f}_{k} \qquad ( 5 )$$

In accordance with the present invention, the total timing drift T should not be allowed to exceed a predefined threshold timing drift Tₜ. The threshold timing drift Tₜ, in turn, should not be higher than the UMTS specified requirement of one quarter-chip, and preferably with a margin of about 0.1 chips. In addition, the frequency error Δƒ for each time slot should not be allowed to exceed a predefined threshold frequency error Fₜ. The threshold frequency error Fₜ must be at least as high as the frequency sensitivity FREQsen of the receiver unit, which must not be higher than 200 Hz or some other maximum specified frequency error.

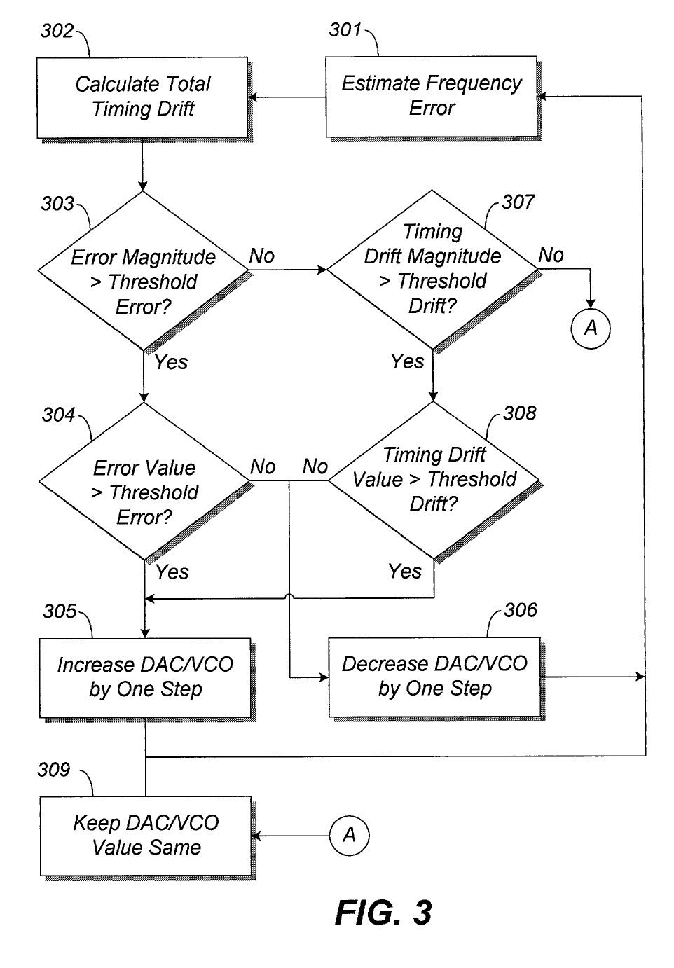

Referring now to FIG. 3, operation of the automatic frequency control algorithm of the present invention begins at step 301 wherein, for each time slot, a frequency error Δƒ is estimated. At step 302, the automatic frequency control algorithm calculates a total timing drift T according to either Equations (4) or (5) above, depending on whether the frequency error Δƒ is constant or varying with each time slot. The value of the total timing drift T may be initially set to 0, then allowed to increase or decrease with each subsequent iteration of step 302.

A determination is made at step 303 as to whether the magnitude of the estimated frequency error |Δƒ| is greater than a predefined threshold frequency error Fₜ. If the answer at step 303 is “Yes” (a “No” answer is discussed later below), then another determination is made at step 304 as to whether the actual value of the estimated frequency error Δƒ is greater than the threshold frequency error Fₜ. If the answer at step 304 is “Yes,” then at step 305, the DAC, and hence the VCO, are incremented by one step or resolution unit. If the answer at step 304 is “No,” then at step 306, the DAC, and hence the VCO, are decremented by one step or resolution unit. The automatic frequency algorithm thereafter returns to step 301 to estimate the frequency error for the next time slot.

Note that the steps 305 and 306 of incrementing and decrementing the DAC and VCO, respectively, include the step of outputting the frequency error Δƒ from the automatic frequency control unit to the conversion unit for conversion into a digital value. In addition, although the incrementing and decrementing steps are described in terms of a single resolution unit, in some embodiments, an increase or decrease of more than one resolution unit may be desirable. For example, more than one resolution unit may be used where the frequency sensitivity FREQsen of the receiver is very small, or where a very large frequency error suddenly occurs, depending on the characteristics of the DAC and the design of the automatic frequency control unit.

If the answer at step 303 is “No,” then a determination is made at step 307 as to whether the magnitude of the total timing drift |T| up to the current time slot is greater than a predefined threshold drift Tₜ. If the answer at step 307 is “No,” then no change is made to the DAC/VCO, that is, the DAC/VCO values are kept the same at step 309. If the answer at step 307 is “Yes,” then at step 308, another determination is made as to whether the actual value of the total timing drift T is greater than a predefined threshold drift Tₜ. If the answer at step 308 is “Yes,” then the DAC/VCO is incremented by one step or resolution unit in the manner described above with respect to step 305. If the answer at step 308 is “No,” then the DAC/VCO is decremented by one step or resolution unit in the manner described above with respect to step 306. In this way, the direction of the total timing drift may be reversed before the total timing drift T becomes too large. The automatic frequency control algorithm thereafter returns to step 301 for further processing.

Following is a simple illustration of the operation of the automatic frequency algorithm shown and described with respect to FIG. 3. Recall that UMTS specifies the maximum frequency error and timing drift to be 200 Hz and one quarter-chip, respectively, and assume that the frequency sensitivity, FREQsen, of the receiver is 150 Hz. Accordingly, the threshold frequency error Fₜ should be set somewhere between 150 Hz and 200 Hz, say, 170 Hz, and the threshold drift Tₜ should be less than a quarter-chip, say, 0.1 chips. Assume further that the total timing drift T is initially set to 0, and that the frequency error Δƒ (see Equation (1)) has remained at 100 Hz for several time slots so that the use of Equation (4) is appropriate. At the first time slot (x=1), the magnitude of the frequency error |Δƒ| is not greater than the threshold frequency error Fₜ, and the magnitude of the total timing drift |T| is not greater than the predefined threshold drift Tₜ. This means that the answer is “No” at both steps 302 and 307, and the DAC and VCO values are kept the same.

At the 751st time slot (x=751), however, the total timing drift T becomes greater than the threshold drift Tₜ according to Equation (4). The answer to step 307 then become “Yes,” as does the answer to step 308. The DAC and VCO are subsequently increased by one step or resolution unit, which increases the reference frequency by 150 Hz. At the next time slot, an estimate of the frequency error now produces an error Δƒ of −50 50 Hz. Consequently, the total timing drift T will now begin to drift in the opposite direction.

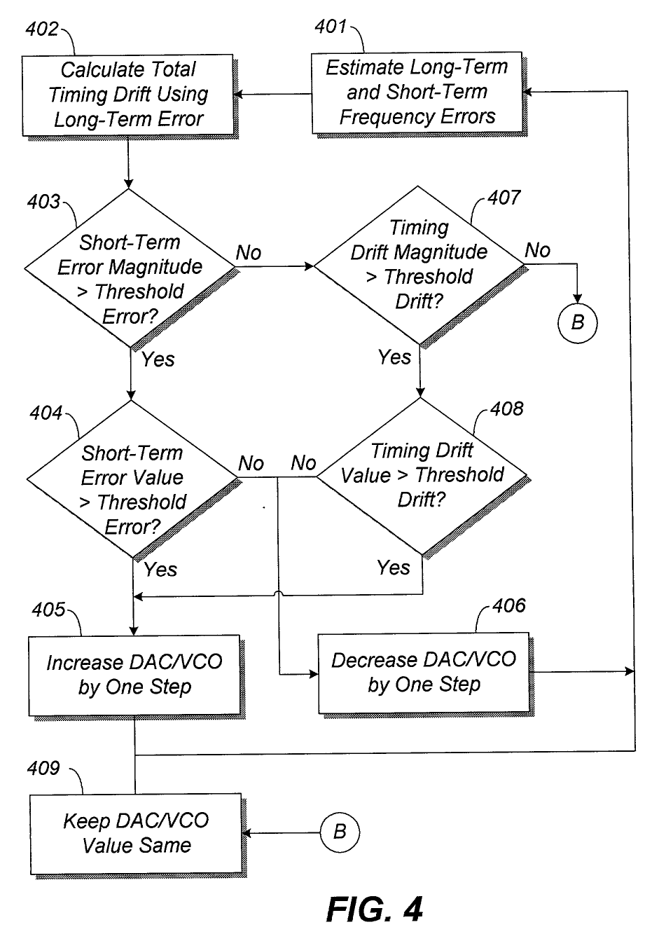

Referring now to FIG. 4, in some embodiments, the estimated frequency error Δƒ may be filtered using different data filters. Thus, at step 401, the estimated frequency error Δƒ may be filtered using error estimates from, for example, one or more preceding time slots, an average of error estimates taken over time, and the like. The result is an enhanced frequency error Δƒ₁ which is more suitable for long-term timing synchronization, and a conventional frequency error Δƒ₂ which is more suitable for short-term timing synchronization. In these embodiments, the total timing drift T calculations and determinations are performed using the long-term frequency error Δƒ₁, whereas the conventional frequency error determinations are performed using the short-term frequency error Δƒ₂. Thus, in FIG. 4, steps 403 and 404 are otherwise identical to their counterparts in FIG. 3 except for the use of the short-term frequency error Δƒ₂. Similarly, steps 402, 407, and 408 are otherwise identical to their counterpart in FIG. 3 except for the use of the long-term frequency error Δƒ₁. In this way, the effectiveness of the automatic frequency control algorithm for long-term synchronization may be improved, depending on the requirements and characteristic of the particular application.

Although the long-term frequency error Δƒ₁ is used for timing drift determinations and the short-term frequency error Δƒ₂ is used for conventional frequency error determinations in the automatic frequency control algorithm of FIG. 4, the invention is not to be limited thereto. In some embodiments, the short-term frequency error Δƒ₂ is used for timing drift determinations and the long-term frequency error Δƒ₁ is used for conventional frequency error determinations, depending on which arrangement produces the optimal results for the particular application.

As demonstrated by the foregoing description, embodiments of the present invention provide an automatic frequency control method and apparatus that is capable of reducing the number of timing changes that must be made due to frequency errors in a mobile communication device. Advantages of the invention include minimal or no changes required to the existing receiver unit hardware. In addition, the existing frequency sensitivity of the receiver unit may be used, thereby avoiding the costs and complexity associated with improving frequency sensitivity in the receiver unit. Additional advantages of the invention will be apparent to those of ordinary skill in the art from the foregoing detailed description and the claims appended herebelow.

While a limited number of embodiments have been disclosed herein, those of ordinary skill in the art will recognize that variations and modifications from the described embodiments may be derived without departing from the scope of the invention. For example, while embodiments of the invention have been described with respect to UMTS, the invention is not to be limited thereto and may certainly be applicable to other mobile communication systems. All numerical values disclosed herein are approximate values only regardless of whether that term was used in describing the values. Accordingly, the appended claims are intended to cover all such variations and modifications as falling within the scope of the invention.

What is claimed is:

1. A method of controlling frequency in a mobile communication device, the method comprising:
estimating a frequency error for the mobile communication device;
calculating a total timing drift for the mobile communication device using the estimated frequency error;
determining whether a magnitude of the estimated frequency error is greater than a predefined error threshold;
determining whether a magnitude of the total timing drift is greater than a predefined drift threshold if the magnitude of the estimated frequency error is determined to be not greater than the predefined error threshold; and
adjusting the frequency of the mobile communication device to reverse a direction of the total timing drift if the magnitude of the total timing drift is determined to be greater than the predefined drift threshold.

2. The method according to claim 1, further comprising keeping the frequency of the mobile communication device the same if the magnitude of the total timing drift is determined to be not greater than the predefined drift threshold.

3. The method according to claim 1, wherein the adjusting step includes decreasing a reference frequency of the mobile communication device if a value of the total timing drift is determined to be not greater than the predefined drift threshold.

4. The method according to claim 1, wherein the adjusting step includes increasing a reference frequency of the mobile communication device if a value of the total timing drift is determined to be greater than the predefined drift threshold.

5. The method according to claim 1, further comprising changing the frequency of the mobile communication device if the magnitude of the estimated frequency error is determined to be greater than the predefined error threshold.

6. The method according to claim 5, wherein the step of changing includes decreasing a reference frequency of the mobile communication device if a value of the estimated frequency error is determined to be not greater than the predefined error threshold.

7. The method according to claim 5, wherein the step of changing includes increasing a reference frequency of the mobile communication device if a value of the estimated frequency error is determined to be greater than the predefined error threshold.

8. The method according to claim 1, wherein the step of adjusting includes decrementing or incrementing a voltage controlled oscillator by one resolution unit at a time.

9. The method according to claim 5, wherein the step of changing includes decrementing or incrementing a voltage controlled oscillator by one resolution unit at a time.

10. A mobile communication device, comprising:
a transceiver unit;
a voltage controlled oscillator adapted to generate a reference frequency signal for the transceiver unit; and
a frequency control unit adapted to control the reference frequency generated by the voltage controlled oscillator, the frequency control unit configured to:
estimate a frequency error for the mobile communication device;
calculate a total timing drift for the mobile communication device using the estimated frequency error;
determine whether a magnitude of the estimated frequency error is greater than a predefined error threshold;
determine whether a magnitude of the total timing drift is greater than a predefined drift threshold if the magnitude of the estimated frequency error is determined to be not greater than the predefined error threshold; and
adjust the frequency of the mobile communication device to reverse a direction of the total timing drift if the magnitude of the total timing drift is determined to be greater than the predefined drift threshold.

11. The mobile communication device according to claim 10, wherein the frequency control unit is further configured to keep the frequency of the mobile communication device the same if the magnitude of the total timing drift is determined to be not greater than the predefined drift threshold.

12. The mobile communication device according to claim 10, wherein the frequency control unit adjusts the frequency of the mobile communication device by decreasing the reference frequency if a value of the total timing drift is determined to be not greater than the predefined drift threshold.

13. The mobile communication device according to claim 10, wherein the frequency control unit adjusts the frequency of the mobile communication device by increasing the reference frequency if a value of the total timing drift is determined to be greater than the predefined drift threshold.

14. The mobile communication device according to claim 10, wherein the frequency control unit is further configured to change the frequency of the mobile communication device if the magnitude of the estimated frequency error is determined to be greater than the predefined error threshold.

15. The mobile communication device according to claim 14, wherein the frequency control unit changes the frequency of the mobile communication device by decreasing the reference frequency if a value of the estimated frequency error is determined to be not greater than the predefined error threshold.

16. The mobile communication device according to claim 14, wherein the frequency control unit changes the frequency of the mobile communication device by increasing the reference frequency if a value of the estimated frequency error is determined to be greater than the predefined error threshold.

17. The mobile communication device according to claim 10, wherein the frequency control unit adjusts the frequency of the mobile communication device by decrementing or incrementing a voltage controlled oscillator by one resolution unit at a time.

18. The mobile communication device according to claim 14, wherein the frequency control unit adjusts the frequency of the mobile communication device by decrementing or incrementing a voltage controlled oscillator by one resolution unit at a time.

19. A method of controlling frequency in a mobile communication device, the method comprising:
estimating a long-term frequency error and a short-term frequency error for the mobile communication device;
calculating a total timing drift for the mobile communication device using the long-term frequency error;
determining whether a magnitude of the short-term frequency error is greater than a predefined error threshold;
determining whether a magnitude of the total timing drift is greater than a predefined drift threshold if the magnitude of the short-term frequency error is determined to be not greater than the predefined error threshold; and
adjusting the frequency of the mobile communication device to reverse a drift direction of the total timing drift if the magnitude of the total timing drift is determined to be greater than the predefined drift threshold.

20. The method according to claim 19, further comprising keeping the frequency of the mobile communication device the same if the magnitude of the total timing drift is determined to be not greater than the predefined drift threshold.

21. The method according to claim 19, wherein the adjusting step includes decreasing a reference frequency of the mobile communication device if a value of the total timing drift is determined to be not greater than the predefined drift threshold.

22. The method according to claim 19, wherein the adjusting step includes increasing a reference frequency of the mobile communication device if a value of the total timing drift is determined to be greater than the predefined drift threshold.

23. The method according to claim 19, further comprising changing the frequency of the mobile communication device if the magnitude of the short-term frequency error is determined to be greater than the predefined error threshold.

24. The method according to claim 23, wherein the step of changing includes decreasing a reference frequency of the mobile communication device if a value of the short-term frequency error is determined to be not greater than the predefined error threshold.

25. The method according to claim 23, wherein the step of changing includes increasing a reference frequency of the mobile communication device if a value of the short-term frequency error is determined to be greater than the predefined error threshold.

26. The method according to claim 19, wherein the step of adjusting includes decrementing or incrementing a voltage controlled oscillator by one resolution unit at a time.

27. The method according to claim 23, wherein the step of changing includes decrementing or incrementing a voltage controlled oscillator by one resolution unit at a time.

28. A mobile communication device, comprising:
a transceiver unit;
a voltage controlled oscillator adapted to generate a reference frequency signal for the transceiver unit; and
a frequency control unit adapted to control the reference frequency generated by the voltage controlled oscillator, the frequency control unit configured to:
estimate a long-term frequency error and a short-term frequency error for the mobile communication device;
calculate a total timing drift for the mobile communication device using the long-term frequency error;
determine whether a magnitude of the short-term frequency error is greater than a predefined error threshold;
determine whether a magnitude of the total timing drift is greater than a predefined drift threshold if the magnitude of the short-term frequency error is determined to be not greater than the predefined error threshold; and
adjust the frequency of the mobile communication device to reverse a drift direction of the total timing drift if the magnitude of the total timing drift is determined to be greater than the predefined drift threshold.

29. The mobile communication device according to claim 28, wherein the frequency control unit is further configured to keep the frequency of the mobile communication device the same if the magnitude of the total timing drift is determined to be not greater than the predefined drift threshold.

30. The mobile communication device according to claim 28, wherein the frequency control unit adjusts the frequency of the mobile communication device by decreasing the reference frequency if a value of the total timing drift is determined to be not greater than the predefined drift threshold.

31. The mobile communication device according to claim 28, wherein the frequency control unit adjusts the frequency of the mobile communication device by increasing the reference frequency if a value of the total timing drift is determined to be greater than the predefined drift threshold.

32. The mobile communication device according to claim 28, wherein the frequency control unit is further configured to change the frequency of the mobile communication device if the magnitude of the short-term frequency error is determined to be greater than the predefined error threshold.

33. The mobile communication device according to claim 32, wherein the frequency control unit changes the frequency of the mobile communication device by decreasing the reference frequency if a value of the short-term frequency error is determined to be not greater than the predefined error threshold.

34. The mobile communication device according to claim 32, wherein the frequency control unit changes the frequency of the mobile communication device by increasing the reference frequency if a value of the short-term frequency error is determined to be greater than the predefined error threshold.

35. The mobile communication device according to claim 28, wherein the frequency control unit adjusts the frequency of the mobile communication device by decrementing or incrementing a voltage controlled oscillator by one resolution unit at a time.

36. The mobile communication device according to claim 32, wherein the frequency control unit adjusts the frequency of the mobile communication device by decrementing or incrementing a voltage controlled oscillator by one resolution unit at a time.
